(19) United States
(12) Patent Application Publication
(10) Pub. No.: US 2025/0048384 A1
(43) Pub. Date: Feb. 6, 2025

(54) METHOD AND APPARATUS FOR APPLYING TRANSMISSION CONFIGURATION INDICATOR (TCI) STATE

(71) Applicant: FG Innovation Company Limited, Tuen Mun (HK)

(72) Inventors: CHIA-HSIN LAI, Taipei (TW); MEI-JU SHIH, Taipei (TW); WAN-CHEN LIN, Taipei (TW); CHIA-HUNG LIN, Taipei (TW); YEN-HUA LI, Taipei (TW)

(21) Appl. No.: 18/792,035

(22) Filed: Aug. 1, 2024

Related U.S. Application Data
(60) Provisional application No. 63/530,157, filed on Aug. 1, 2023.

(51) Int. Cl. H04W 72/231; H04L 1/1812; H04W 36/04; H04W 56/00

(52) U.S. Cl. CPC H04W 72/231; H04L 1/1812; H04W 36/04; H04W 56/0045

(57) ABSTRACT

A method performed by a User Equipment (UE) for applying a Transmission Configuration Indicator (TCI) state is provided. The method receives a Radio Resource Control (RRC) configuration. The method receives a first Medium Access Control (MAC) Control Element (CE) for activating at least one TCI state configured by the RRC configuration. The method receives Downlink Control Information (DCI) for indicating a first TCI state among the at least one TCI state activated by the first MAC CE. The method receives a second MAC CE for indicating a second TCI state after receiving the DCI. The method then applies the first TCI state or the second TCI state for a target cell.

### CROSS-REFERENCE TO RELATED APPLICATION(S)

The present disclosure claims the benefit of and priority to U.S. Provisional Patent Application Ser. No. 63/530,157, filed on Aug. 1, 2023, entitled “METHOD AND APPARATUS TO ENHANCE BEAM INDICATION IN LTM,” the content of which is hereby incorporated herein fully by reference into the present disclosure for all purposes.

### FIELD

The present disclosure is related to wireless communication and, more specifically, to a User Equipment (UE), Base Station (BS), and method for indicating and/or applying a Transmission Configuration Indicator (TCI) state in the wireless communication networks.

### BACKGROUND

Various efforts have been made to improve different aspects of wireless communication for the cellular wireless communication systems, such as the 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the next-generation wireless communication systems.

### SUMMARY

The present disclosure is related to a UE, a BS, and a method for indicating and/or applying a Transmission Configuration Indicator (TCI) state in the wireless communication networks.

In a first aspect of the present application, a method performed by a UE for applying a TCI state is provided. The method includes receiving a Radio Resource Control (RRC) configuration; receiving a first Medium Access Control (MAC) Control Element (CE) for activating at least one TCI state configured by the RRC configuration; receiving Downlink Control Information (DCI) for indicating a first TCI state among the at least one TCI state activated by the first MAC CE; receiving a second MAC CE for indicating a second TCI state after receiving the DCI; and applying the first TCI state or the second TCI state for a target cell.

In some implementations of the first aspect, the first TCI state and the second TCI state are the same.

In some implementations of the first aspect, the method further includes switching from a source cell to the target cell based on the second MAC CE. The second MAC CE includes a Layer1/Layer2 Triggered Mobility (LTM) cell switch command MAC CE. The first TCI state or the second TCI state is applied after switching to the target cell.

In some implementations of the first aspect, the second MAC CE includes a TCI state identifier (ID) for indicating the second TCI state.

In some implementations of the first aspect, the second MAC CE includes an identifier associated with the target cell and timing advance information for indicating whether a time advance is valid for the target cell.

In some implementations of the first aspect, the method further includes transmitting a Hybrid Automatic Repeat Acknowledgement (HARQ-ACK) corresponding to the DCI after receiving the second MAC CE.

In some implementations of the first aspect, the first TCI state or the second TCI state is applied starting from a slot that is at least a specific duration after the transmission of the HARQ-ACK.

In a second aspect of the present application, a UE for applying a TCI state is provided. The UE includes at least one processor and at least one non-transitory computer-readable medium that is coupled to the at least one processor and that stores one or more computer-executable instructions. The computer-executable instructions, when executed by the at least one processor, cause the UE to: receive an RRC configuration; receive a first MAC CE for activating at least one TCI state configured by the RRC configuration; receive DCI for indicating a first TCI state among the at least one TCI state activated by the first MAC CE; receive a second MAC CE for indicating a second TCI state after receiving the DCI; and apply the first TCI state or the second TCI state for a target cell.

In a third aspect of the present application, a BS for indicating a TCI state is provided. The BS includes at least one processor and at least one non-transitory computer-readable medium that is coupled to the at least one processor and that stores one or more computer-executable instructions. The computer-executable instructions, when executed by the at least one processor, cause the BS to: transmit, to a UE, an RRC configuration; transmit, to the UE, a first MAC CE for activating at least one TCI state configured by the RRC configuration; transmit, to the UE, DCI for indicating a first TCI state among the at least one TCI state activated by the first MAC CE; and transmit, to the UE, a second MAC CE for indicating a second TCI state after transmitting the DCI. The second MAC CE enables the UE to apply the first TCI state or the second TCI state for a target cell.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process performed by a UE for applying a TCI state, according to an example implementation of the present disclosure.

FIG. 2 is a flowchart illustrating a method/process performed by a BS for indicating a TCI state, according to an example implementation of the present disclosure.

FIG. 3 is a block diagram illustrating a node for wireless communication, according to an example implementation of the present disclosure.

### DETAILED DESCRIPTION

Some of the abbreviations used in the present disclosure include:

### Abbreviation Full Name

ACK Acknowledgement
BA Bandwidth Adaptation
BFR Beam Failure Recovery
BSR Buffer Status Report
BWP Bandwidth Part
CA Carrier Aggregation
CBG Code Block Group
CC Component Carrier
CCCH Common Control Channel
CE Control Element
CG Configured Grant
CH Channel
CORESET Control Resource Set
CQI Channel Quality Indicator
CRC Cyclic Redundancy Check
CRI CSI-RS resource indicator
CSI Channel State Information
CSI-IM CSI Interference Measurement
CSI-RS CSI Reference Signal
CSS Common Search Space
DCI Downlink Control Information
DCP DCI with CRC scrambled by PS-RNTI
DFI Downlink Feedback Indication
DL Downlink
DM-RS Demodulation Reference Signal
DRX Discontinuous Reception
eLCID Extended Logical Channel ID
FR Frequency Range
HARQ Hybrid Automatic Repeat reQuest
ID Identification/Identifier
LBT Listen Before Talk
LSB Least Significant Bit
LTM Layer 1/Layer 2 Triggered Mobility
L1 Layer 1
L2 Layer 2
L3 Layer 3
MAC Medium Access Control
MCG Master Cell Group
MCS Modulation Coding Scheme
MSB Most Significant Bit
NACK Negative Acknowledgment
NR-U New Radio Unlicensed
NW Network
NZP Non Zero Power
PBCH Physical Broadcast Channel
PDCCH Physical Downlink Control Channel
PDCP Packet Data Convergence Protocol
PDSCH Physical Downlink Shared Channel
PCell Primary Cell
PCI Physical Cell ID
PHR Power Headroom Report
PMI Precoding Matrix Indicator
PRACH Physical Random Access Channel
PSCell Primary SCG Cell
PTAG Primary Timing Advance Group
PUCCH Physical Uplink Control Channel
PUSCH Physical Uplink Shared Channel
QCL Quasi Co Location
RA Random Access
RAR Random Access Response
Rel Release
RF Radio Frequency
RLC Radio Link Control
RRC Radio Resource Control
RS Reference Signal
RSRP Reference Signal Received Power
SCell Secondary Cell
SCG Secondary Cell Group
SCS Subcarrier Spacing
SDAP Service Data Adaptation Protocol
SINR Signal to Interference plus Noise Ratio
SL Sidelink
SLIV Start and Length Indicator Value
SpCell Special Cell
SPS Semi-Persistent Scheduling
SR Scheduling Request
SS Synchronization Signal
SSB Synchronization Signal Block
SSBRI SS/PBCH Block Resource indicator
TBG Transport Block Group
TCI Transmission Configuration Indicator
TDRA Time Domain Resource Allocation
TRP Transmission Reception Point
UCI Uplink Control Information
UE User Equipment
UL Uplink
USS UE-specific search space

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using multiple cells forming the RAN. The BS may support the operations of the cells. Each cell may be operable to provide services to at least one UE within its radio coverage.

Each cell (may often referred to as a serving cell) may provide services to one or more UEs within the cell's radio coverage, such that each cell schedules the DL (and optionally UL resources) to at least one UE within its radio coverage for DL (and optionally UL packet transmissions from the UE). The BS may communicate with one or more UEs in the radio communication system via the cells.

A cell may allocate sidelink (SL) resources for supporting Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically, Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more of the following sentences, paragraphs, (sub)-bullets, points, actions, behaviors, terms, alternatives, aspects, examples, or claims described in the following disclosure(s) may be combined logically, reasonably, and properly to form a specific method.

Any sentence, paragraph, (sub)-bullet, point, action, behaviors, terms, alternatives, aspects, examples, or claims described in the following disclosure(s) may be implemented independently and separately to form a specific method.

Dependency, e.g., “based on”, “more specifically”, “preferably”, “In one embodiment”, “In one alternative”, “In one example”, “In one aspect”, or etc., in the following disclosure(s) is just one possible example which would not restrict the specific method

One aspect of the present solution/disclosure may be used, for example, in a communication, communication equipment (e.g., a mobile telephone apparatus, ad base station apparatus, a wireless LAN apparatus, and/or a sensor device, etc.), and integrated circuit (e.g., a communication chip) and/or a program, etc.

According to any two or more of the following sentences, paragraphs, (sub)-bullets, points, actions, behaviors, terms, alternatives, aspects, examples, embodiments, or claims described in the following disclosure(s), “X/Y” includes the meaning of “X or Y”.

According to any two or more of the following sentences, paragraphs, (sub)-bullets, points, actions, behaviors, terms, alternatives, aspects, examples, embodiments, or claims described in the following disclosure(s), “X/Y” includes the meaning of “X and Y”.

According to any two or more of the following sentences, paragraphs, (sub)-bullets, points, actions, behaviors, terms, alternatives, aspects, examples, embodiments, or claims described in the following disclosure(s), “X/Y” includes the meaning of “X and/or Y”.

Examples of some selected terms in the present disclosure are provided as follows.

User Equipment (UE): The UE may include a PHY/MAC/RLC/PDCP/SDAP entity. The PHY/MAC/RLC/PDCP/SDAP entity may also be referred to as the UE.

Network (NW): The NW may include a network node, a TRP, a cell (e.g., SpCell, PCell, PSCell, and/or SCell), an eNB, a gNB, and/or a base station.

Serving Cell: A PCell, a PSCell, or an SCell may be referred to as a serving cell. The serving cell may include an activated or a deactivated serving cell.

Special Cell (SpCell): For a Dual Connectivity operation the term Special Cell may include the PCell of the MCG or the PSCell of the SCG depending on whether the MAC entity is associated with the MCG or the SCG, respectively. Otherwise, the term Special Cell may include the PCell. A Special Cell may support the PUCCH transmission and the contention-based Random Access and may be always activated.

### Beam Application Time

Beam activation and indication are important issues when considering which beam a UE may apply. A beam may correspond to one or more TCI states. There are some different ways for the NW to configure, indicate, and/or activate one or more beams for the UE.

In some implementations, if only one TCI state is configured, the UE may apply the TCI state after the TCI state is configured. In some implementations, if a TCI state is configured, the UE may apply the configured TCI state immediately.

In some implementations, if more than one TCI state is configured, the UE may receive an activation command that activates at least one TCI state or at least one pair of TCI states. Each pair of TCI states may include a TCI state for the DL channels/signals and a TCI state for the UL channels/signals. In some implementations, the activation command may activate up to 8 TCI states or 8 pairs of TCI states. The activation command may be used to map up to 8 TCI states or 8 pairs of TCI states to the codepoints of a DCI field “Transmission Configuration Indication” for one or more CCs/DL BWPs, and if applicable, for one or more CCs/UL BWPs. In some implementations, when the UE transmits, in a slot n, a PUCCH with HARQ-ACK information corresponding to the PDSCH carrying the activation command or corresponding to the DCI without DL assignment (e.g., PDSCH scheduled by the DCI), the indicated mapping between the TCI states and the codepoints of the DCI field “Transmission Configuration Indication” may be applied starting from the first slot that is after slot n+3Nₛₗₒₜ^{subframe,μ} where n is a positive integer indicating a slot number, μ is the SCS configuration for the PUCCH and Nₛₗₒₜ^{subframe,μ} is the number of slots in a subframe under the SCS configuration μ.

In some implementations, if the parameter tci-PresentInDCI is set to “enabled” or the parameter tci-PresentDCI-1-2 is configured for the CORESET scheduling the PDSCH, and the time offset between the reception of the DL DCI and the corresponding PDSCH is equal to or greater than a threshold (e.g., the timeDurationForQCL), the UE may determine that the DM-RS ports of the PDSCH of a serving cell are quasi co-located with the SS/PBCH block determined in the initial access procedure with respect to the qcl-Type set to “typeA” and, when applicable, also with respect to the qcl-Type set to “typeD”. This determination may be made after the UE receives an initial higher layer configuration of the TCI states and before the reception of the activation command.

In some implementations, if a PDSCH is scheduled by a DCI format having the TCI field, the TCI field in the scheduling component carrier may point to the activated TCI states in the scheduled component carrier or the DL BWP. The UE may use the TCI-State according to the value of the “Transmission Configuration Indication” field in the detected PDCCH with DCI for determining the PDSCH antenna port quasi co-location. The UE may determine that the DM-RS ports of the PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL.

In some implementations, when a UE configured with the dl-OrJointTCI-StateList transmits a PUCCH or PUSCH with a positive HARQ-ACK, and the indicated TCI State is different from the previously indicated one, the indicated TCI-State and/or the TCI-UL-State may be applied starting from the first slot that is at least a specific duration (e.g., the beamAppTime) of symbols after the last symbol of the PUCCH or PUSCH with the HARQ-ACK. The positive HARQ-ACK may correspond to the DCI carrying the TCI State indication and without the DL assignment or correspond to the PDSCH scheduled by the DCI carrying the TCI State indication.

The first slot and the specific duration (e.g., the beamAppTime) of symbols may be both determined on the active BWP with the smallest SCS among the BWP(s) from the CCs applying the indicated TCI-State or TCI-UL-State that are active at the end of the PUCCH or PUSCH carrying the positive HARQ-ACK. In some implementations, the specific duration (e.g., the beamAppTime) may indicate the first slot to apply the unified TCI indicated by the DCI. The value n1 means 1 symbol, n2 means two symbols, and so on. The first slot may be at least Y symbols (Y being a positive integer) indicated by the beamAppTime parameter after the last symbol of the ACK of the joint or separate DL/UL beam indication. The same value may be configured for all the serving cells in any one of the simultaneousU-TCI-UpdateListN configured in an IE CellGroupConfig based on the smallest SCS of the active BWP.

In an LTM procedure, the one or more TCI states may be associated with one or more reference signals, which may include the CSI-RSs and/or SSBs. The one or more TCI states may be associated with one or more serving cells. The one or more serving cells may include serving cell(s), candidate cell(s), and/or a target cell. Furthermore, a specific parameter (e.g., additionalPCI) may be configured to indicate the physical cell IDs (PCI) or logical cell IDs of the CSI-RSs and/or SSBs when the one or more reference signals are configured as the CSI-RSs and/or SSBs for both the QCL-Type1 and QCL-Type2. The physical cell IDs (PCI) or the logical cell IDs may correspond to the candidate cell(s) and/or a target cell.

In an LTM procedure, the beam (or TCI state) activation and indication are important issues when considering which beam (or TCI state) a UE may apply and when the beam (or TCI state) may be applied. There may be some different ways for the NW to configure, indicate, and/or activate one or more beams (and/or TCI states) for the UE which may cause different beam application times.

In some implementations, a cell switch command may indicate one or more TCI states. However, when to apply the one or more TCI states may need to be considered when the beam (or TCI state) indication and/or the beam (or TCI state) activation are supported in the cell switch command. In some implementations, the cell switch command may include the beam (or TCI state) indication and/or the beam (or TCI state) activation. The cell switch command may further include at least one of the following fields: a candidate cell ID, a target cell ID, timing advance, a logical (cell) ID, and a TCI state. If the time for applying the one or more TCI states is not defined when the beam indication and/or activation is supported, the UE and the NW may share different beam information, which may cause ambiguity between the transmission and reception.

In some implementations, the cell switch command may indicate one or more TCI states. Different UE behaviors may need to be defined in response to the different cell switch command reception timings. If the UE behavior(s) is/are not defined, the UE and the NW may not share the same transmission and reception behaviors.

It should be noted that the cell switch command may correspond to a first MAC CE, an activation command may correspond to a second MAC CE, and some cell switch command reception timings in the present disclosure may be listed as follows:

In some implementations, the UE may receive a first PDSCH carrying the first MAC CE between a second PDSCH carrying the second MAC CE and a second HARQ-ACK corresponding to the second MAC CE.

In some implementations, the UE may receive a first PDSCH carrying the first MAC CE during 3Nₛₗₒₜ^{subframe,μ} slots after a second HARQ-ACK corresponding to the second MAC CE.

In some implementations, the UE may receive a first PDSCH carrying the first MAC CE between a second HARQ-ACK corresponding to the second MAC CE and a PDCCH with a DCI field indicating one or more TCI states.

In some implementations, the UE may receive a first PDSCH carrying the first MAC CE between a PDCCH with a DCI field indicating one or more TCI states and a third HARQ-ACK corresponding to the PDCCH.

In some implementations, the UE may receive a first PDSCH carrying the first MAC CE during a first specific duration configured by a higher layer parameter after a third HARQ-ACK corresponding to a PDCCH with a DCI field indicating one or more TCI states.

In some implementations, the UE may start applying the one or more TCI states after a second specific duration configured by a higher layer parameter.

In some implementations, if a HARQ-ACK corresponding to the second MAC CE is transmitted in a slot n, the UE may start applying the one or more TCI states from the first slot that is after slot n+3Nₛₗₒₜ^{subframe,μ}.

It should be noted that the cell switch command described in the present disclosure may include an LTM cell switch command MAC CE.

It should be noted that the activation command described in the present disclosure may include a Candidate cell TCI state activation/deactivation MAC CE.

It should be noted that the DCI (which may include a DCI field indicating one or more TCI states and/or pairs of TCI states) may be used to indicate one or more TCI states and/or pairs of TCI states with or without scheduling a PDSCH.

### Beam Indication and Application Time

In some implementations, the RRC signaling (e.g., an RRC message) may include an RRC configuration that configures a TCI state and/or a pair of TCI states associated with the candidate cell(s) and/or target cell(s). It should be noted that the pair of TCI states may include one DL TCI state and one UL TCI state (e.g., for a separate mode); one DL TCI state (e.g., for a first TRP) and another DL TCI state (e.g., for a second TRP); or one UL TCI state (e.g., for the first TRP) and another UL TCI state (e.g., for the second TRP). The candidate cell may include a neighboring cell that is considered to be a potential target cell for an LTM procedure, and the target cell may include a specific cell that is selected from at least one candidate cell to which the UE switches.

In some implementations, the UE may be provided with a configured TCI state and/or pairs of TCI states associated with the candidate cells and/or a target cell. The UE may receive a PDSCH corresponding to a cell switch command that may include a beam indication (e.g., a TCI state and/or a pair of TCI states). The UE may apply the configured TCI state and/or pairs of TCI states after or when the UE changes/switches to the target cell. In some implementations, the UE may apply the configured TCI state and/or pairs of TCI states after the cell switch command is received, for example, after the last symbol of a PDSCH that carries the cell switch command. In some implementations, the UE may transmit a PUCCH or PUSCH with a positive HARQ-ACK corresponding to the cell switch command (which may include an indication and activation for the same TCI state or for different TCI states), and the configured TCI state and/or pairs of TCI states may be applied starting from the first slot that is at least a specific duration (e.g., the beamAppTime, a Nₛₗₒₜ^{subframe,μ} slot, or the timeDurationForQCL) after the last symbol of the PUCCH or PUSCH with the HARQ-ACK.

In some implementations, when the UE transmits, in a slot n, a PUCCH with HARQ-ACK information corresponding to the PDSCH carrying the cell switch command, which may indicate a TCI state and/or a pair of TCI states, the indicated beam indication (e.g., TCI state and/or pair of TCI states) may be applied starting from the first slot that is after slot n+3Nₛₗₒₜ^{subframe,μ} or

$$slot n + 3 {N}_{slot}^{subframe , μ} + \frac{{2}^{μ}}{{2}^{{μ}_{{K}_{mac}}}} \cdot {k}_{m a c} ,$$

where n is a positive integer indicating a slot number, μ may be the SCS configuration for the PUCCH, Nₛₗₒₜ^{subframe,μ} is the number of slots in a subframe under the SCS configuration μ, μ_{K}_{_{mac}} may be the SCS configuration for k_{mac} with a value 0 for FR1 or a value 2 or 3 for FR2, and k_{mac} may be provided by a higher layer parameter K-Mac or k_{mac}=0 if the K-Mac is not provided. In some implementations, Nₛₗₒₜ^{subframe,0}=1, Nₛₗₒₜ^{subframe,1}=2, Nₛₗₒₜ^{subframe,2}=4, Nₛₗₒₜ^{subframe,3}=8, and Nₛₗₒₜ^{subframe,4}=16.

In some implementations, the UE may apply the TCI state and/or pairs of TCI states after a cell switch command processing time. In some implementations, μ may be the SCS configuration for the PUCCH, the SCS configuration for the DCI, the SCS for the PDSCH, or the SCS for the candidate/target cell.

In some implementations, the specific duration may be configured by RRC signaling, and may be set to a fixed value, or set to a value based on the reported UE capability.

In some implementations, the cell switch command processing time may be configured by RRC signaling, may be set to a fixed value, or set to a value based on the reported UE capability.

In some implementations, the UE may receive an RRC message (e.g., an RRC Reconfiguration message) including the configured TCI state and/or pairs of TCI states during an RRC preconfiguration phase during an LTM procedure.

In some implementations, if the RRC message (e.g., the RRC Reconfiguration message) received by the UE includes a TCI state and/or a pair of TCI states during the RRC preconfiguration phase during the LTM procedure, a beam indication related field (e.g., a TCI state field) included in the cell switch command may be absent.

In some implementations, if the RRC message (e.g., the RRC Reconfiguration message) received by the UE includes a TCI state and/or a pair of TCI states during the RRC preconfiguration phase during the LTM procedure, the UE may ignore the beam indicated in the cell switch command (e.g., the LTM cell switch command MAC CE).

In some implementations, the RRC signaling (e.g., an RRC message) may include an RRC configuration that configures more than one TCI state and/or more than one pair of TCI states. One or more of the configured TCI states or the configured pairs of TCI states may be associated with one or more candidate cells or a target cell.

In some implementations, an activation command may activate one of the configured TCI states or one of the configured pairs of TCI states.

In some implementations, if a UE is provided with more than one configured TCI state and/or more than one configured pair of TCI states, one or more of the configured TCI states or the configured pairs of TCI states may be associated with the candidate cells or a target cell. In some implementations, the activation command may activate one of the configured TCI states or one of the configured pairs of TCI states. In some implementations, if the activation command maps a joint TCI state, a TCI-DL-State and/or a TCI-UL-State to only one TCI codepoint, the UE may apply the indicated joint TCI state, the indicated TCI-DL-State, and/or the indicated TCI-UL-State to one or more CCs/DL BWPs, and if applicable, to one or more CCs/UL BWPs once the indicated mapping for the one single TCI codepoint is applied.

In some implementations, when the UE transmits, in a slot n, a PUCCH with HARQ-ACK information corresponding to a PDSCH carrying the activation command, the indicated mapping between the TCI states and the codepoints of a DCI field (e.g., a TCI field) may be applied starting from the first slot that is after slot n+3Nₛₗₒₜ^{subframe,μ} or

$$slot n + 3 {N}_{slot}^{subframe , μ} + \frac{{2}^{μ}}{{2}^{{μ}_{{K}_{mac}}}} \cdot {k}_{m a c} ,$$

where n is a positive integer indicating a slot number, μ may be the SCS configuration for the PUCCH, Nₛₗₒₜ^{subframe,μ} is the number of slots in a subframe under the SCS configuration μ, μ_{K}_{_{mac}} may be the SCS configuration for k_{mac} with a value 0 for FR1 or a value 2 or 3 for FR2, and k_{mac} may be provided by a higher layer parameter K-Mac or k_{mac}=0 if the K-Mac is not provided. In some implementations, Nₛₗₒₜ^{subframe,0}=1, Nₛₗₒₜ^{subframe,1}=2, Nₛₗₒₜ^{subframe,2}=4, Nₛₗₒₜ^{subframe,3}=8, and Nₛₗₒₜ^{subframe,4}=16.

In some implementations, the UE may apply the activated TCI state and/or the activated pair of TCI states after or when the UE changes/switches to the target cell. In some implementations, the UE may apply the activated TCI state and/or the activated pair of TCI states after the cell switch command is received, for example, after the last symbol of a PDSCH that carries the cell switch command. In some implementations, the UE may transmit a PUCCH or PUSCH with a positive HARQ-ACK corresponding to a cell switch command (which may include an indication and activation for the same TCI state or for different TCI states), and the activated TCI state and/or the activated pair of TCI states may be applied starting from the first slot that is at least a specific duration (e.g., the beamAppTime, a Nₛₗₒₜ^{subframe,μ} slot, a threshold, or the timeDurationFor (CL) after the last symbol of the PUCCH or PUSCH with the HARQ-ACK. In some implementations, the UE may apply the activated TCI state and/or the activated pair of TCI states after a cell switch command processing time.

In some implementations, an activation command may activate more than one of the configured TCI states or more than one of the configured pairs of TCI states.

In some implementations, if a UE is provided with more than one configured TCI state and/or more than one configured pair of TCI states, one or more of the configured TCI states or the configured pairs of TCI states may be associated with the candidate cells or a target cell. In some implementations, the activation command may activate more than one of the configured TCI states or more than one of the configured pairs of TCI states. In some implementations, the DCI may indicate one of the TCI states or the pairs of TCI states activated by the activation command.

In some implementations, if the UE is configured with more than one TCI state and/or more than one pair of TCI states, one or more of the configured TCI states or the configured pairs of TCI states may be associated with the candidate cells or the target cell, and the activation command may activate one or more of the configured TCI states or the configured pairs of TCI states. The UE may detect or receive the DCI with a DCI field (e.g., a Transmission Configuration Indication field), and a codepoint of the DCI field may map to the one or more TCI states and/or the one or more pairs of TCI states activated by the activation command. In some implementations, the DCI field may indicate one of the TCI states and/or the pairs of TCI states activated by the activation command. In some implementations, the TCI state and/or the pair of TCI states mapped by the codepoint in the DCI field may be associated with the candidate cells and/or the target cell. In some implementations, the TCI state and/or the pair of TCI states indicated by the DCI field may be associated with the candidate cells and/or the target cell.

In some implementations, if a PDSCH is scheduled by a DCI format having a Transmission Configuration Indication (TCI) field, the UE may use a TCI state (e.g., TCI-State) according to a value of the TCI field in a detected PDCCH with the DCI for determining the PDSCH antenna port quasi co-location. The UE may determine that DM-RS ports of the PDSCH of a serving cell are quasi co-located with the RS(s) in the TCI state with respect to the QCL type parameter(s) given by the indicated TCI state if the time offset between the reception of DL DCI and a corresponding PDSCH is equal to or greater than an offset (or a threshold or the timeDurationForQCL).

In some implementations, the TCI field in the DCI in a scheduling component carrier may point to the activated TCI states in a scheduled component carrier or a DL BWP. In some implementations, if the tci-PresentInDCI is set to “enabled” or the tci-PresentDCI-1-2 is configured for a CORESET scheduling the PDSCH, and the time offset between the reception of the DL DCI and the corresponding PDSCH is equal to or greater than an offset (or a threshold or the timeDurationForQCL), after the UE receives an initial higher layer configuration of TCI states and before reception of an activation command or a Candidate cell TCI state activation/deactivation MAC CE, the UE may determine that the DM-RS ports of the PDSCH of a serving cell are quasi co-located with an SS/PBCH block determined in an initial/random access procedure, e.g., an SS/PBCH block associated with the most recent preamble transmission, with respect to qcl-Type set to “typeA” and, when applicable, also with respect to qcl-Type set to “typeD”.

In some implementations, the initial higher layer configuration may include an RRC pre-configuration message or an RRC reconfiguration message for the LTM operation.

In some implementations, when a UE configured with the dl-OrJointTCI-StateList transmits a PUCCH or PUSCH with a positive HARQ-ACK, and the indicated TCI State is different from the previously indicated one, the indicated joint TCI state, the indicated DL TCI-State and/or the indicated TCI-UL-State may be applied starting from the first slot that is at least a specific duration (e.g., the beamAppTime, a threshold, or the time DurationForQCL) of symbols after the last symbol of the PUCCH or PUSCH with the HARQ-ACK. The positive HARQ-ACK may correspond to the DCI carrying the TCI State indication and without the DL assignment or correspond to the PDSCH scheduled by the DCI carrying the TCI State indication. The first slot and the specific duration (e.g., an offset or the beamAppTime) of symbols may be both determined on an active BWP with the smallest SCS among the BWP(s) from the CCs applying the indicated TCI-State or TCI-UL-State that are active at the end of the PUCCH or PUSCH carrying the positive HARQ-ACK.

In some implementations, the UE may apply the TCI state and/or the pair of TCI states mapped by the codepoint in the DCI field or indicated by the DCI field after or when the UE switches to the target cell. In some implementations, the UE may apply the TCI state and/or the pair of TCI states after the cell switch command is received, for example, after the last symbol of a PDSCH that carries the cell switch command. In some implementations, the UE may transmit a PUCCH or PUSCH with a positive HARQ-ACK corresponding to a cell switch command (which may include indication and activation for the same TCI state or for different TCI states), and the indicated TCI state and/or the indicated pair of TCI states may be applied starting from the first slot that is at least a specific duration (e.g., the beamAppTime, a Nₛₗₒₜ^{subframe,μ} slot, a threshold, or the timeDurationForQCL) after the last symbol of the slot PUCCH or PUSCH with the HARQ-ACK.

In some implementations, when the UE transmits, in a slot n, a PUCCH with HARQ-ACK information corresponding to the PDSCH carrying the cell switch command, which may indicate a TCI state and/or a pair of TCI states, the indicated beam indication (e.g., TCI state and/or pair of TCI states) may be applied starting from the first slot that is after slot n+3Nₛₗₒₜ^{subframe,μ} or

$$slot n + 3 {N}_{slot}^{subframe , μ} + \frac{{2}^{μ}}{{2}^{{μ}_{{K}_{mac}}}} \cdot {k}_{m a c} ,$$

where n is a positive integer indicating a slot number, μ may be the SCS configuration for the PUCCH, Nₛₗₒₜ^{subframe,μ} is the number of slots in a subframe under the SCS configuration μ, μ_{K}_{_{mac}} may be the SCS configuration for k_{mac} with a value 0 for FR1 or a value 2 or 3 for FR2, and k_{mac} may be provided by a higher layer parameter K-Mac or k_{mac}=0 if the K-Mac is not provided. In some implementations, Nₛₗₒₜ^{subframe,0}=1, Nₛₗₒₜ^{subframe,1}=2, Nₛₗₒₜ^{subframe,2}=4, Nₛₗₒₜ^{subframe,3}=8, and Nₛₗₒₜ^{subframe,4}=16.

In some implementations, the UE may apply the TCI state and/or the pair of TCI states after a cell switch command processing time.

In some implementations, the cell switch command may indicate a TCI state and/or a pair of TCI states of the TCI states activated by the activation command.

In some implementations, when the UE detects or receives a PDSCH corresponding to the cell switch command, which may include a beam indication (e.g., a TCI state and/or a pair of TCI states), the UE may apply the beam indication (e.g., the TCI state and/or the pair of TCI states) after a specific duration (e.g., the beamAppTime, a Nₛₗₒₜ^{subframe,μ} slot, a threshold, or the timeDurationForQCL) of symbols after the last symbol of a PUCCH or PUSCH with a positive HARQ-ACK corresponding to the PDSCH corresponding to the cell switch command. In some implementations, when the UE transmits, in a slot n, a PUCCH with HARQ-ACK information corresponding to the PDSCH carrying the cell switch command, which may indicate a TCI state and/or a pair of TCI states, the indicated beam indication (e.g., the TCI state and/or the pair of TCI states) may be applied starting from the first slot that is after slot n+3Nₛₗₒₜ^{subframe,μ} or

$$slot n + 3 {N}_{slot}^{subframe , μ} + \frac{{2}^{μ}}{{2}^{{μ}_{{K}_{mac}}}} \cdot {k}_{m a c} ,$$

where n is a positive integer indicating a slot number, μ may be the SCS configuration for the PUCCH, Nₛₗₒₜ^{subframe,μ} is the number of slots in a subframe under the SCS configuration μ, μ_{K}_{_{mac}} may be the SCS configuration for k_{mac} with a value 0 for FR1 or a value 2 or 3 for FR2, and k_{mac} may be provided by a higher layer parameter K-Mac or k_{mac}=0 if the K-Mac is not provided. In some implementations, Nₛₗₒₜ^{subframe,0}=1, Nₛₗₒₜ^{subframe,1}=2, Nₛₗₒₜ^{subframe,2}=4, Nₛₗₒₜ^{subframe,3}=8, and Nₛₗₒₜ^{subframe,4}=16.

In some implementations, the cell switch command may indicate and activate a TCI state and/or a pair of TCI states of the TCI states configured by the RRC signaling.

In some implementations, when the UE detects or receives a PDSCH corresponding to the cell switch command, which may include beam (or TCI state or pair of TCI states) activation and beam indication (e.g., a TCI state and/or a pair of TCI states), the UE may apply the beam indication (e.g., the TCI state and/or the pair of TCI states) after a specific duration (e.g., the beamAppTime, a Nₛₗₒₜ^{subframe,μ} slot, a threshold, or the time DurationForQCL) of symbols after the last symbol of a PUCCH or PUSCH with a positive HARQ-ACK corresponding to the PDSCH that corresponds to the cell switch command.

In some implementations, when the UE transmits, in a slot n, a PUCCH with HARQ-ACK information corresponding to the PDSCH carrying the cell switch command, which may indicate a TCI state and/or a pair of TCI states, the indicated beam indication (e.g., TCI state and/or pair of TCI states) may be applied starting from the first slot that is after slot n+3Nₛₗₒₜ^{subframe,μ} or

$$slot n + 3 {N}_{slot}^{subframe , μ} + \frac{{2}^{μ}}{{2}^{{μ}_{{K}_{mac}}}} \cdot {k}_{m a c} ,$$

where n is a positive integer indicating a slot number, μ may be the SCS configuration for the PUCCH, Nₛₗₒₜ^{subframe,μ} is the number of slots in a subframe under the SCS configuration μ, μ_{K}_{_{mac}} may be the SCS configuration for k_{mac} with a value 0 for FR1 or a value 2 or 3 for FR2, and k_{mac} may be provided by a higher layer parameter K-Mac or k_{mac}=0 if the K-Mac is not provided. In some implementations, Nₛₗₒₜ^{subframe,0}=1, Nₛₗₒₜ^{subframe,1}=2, Nₛₗₒₜ^{subframe,2}=4, Nₛₗₒₜ^{subframe,3}=8, and Nₛₗₒₜ^{subframe,4}=16. In some implementations, the UE may apply the TCI state and/or the pair of TCI states mapped by the codepoint in the DCI field or indicated by the DCI field after or when the UE changes/switches to the target cell. In some implementations, the UE may apply the TCI state and/or the pair of TCI states after the cell switch command is received, for example, after the last symbol of a PDSCH that carries the cell switch command. In some implementations, the UE may apply the TCI state and/or the pair of TCI states after the cell switch command processing time.
Cell Switch Command with Beam Indication and/or Activation Reception Timing

In some implementations, the cell switch command may be an LTM cell switch command MAC CE, and RRC signaling (an RRC message) may include an RRC configuration that configures more than one TCI state and/or more than one pair of TCI states. One or more of the configured TCI states or the configured pairs of TCI states may be associated with the candidate cells or a target cell.

In some implementations, the activation command may activate one of the configured TCI states or one of the configured pairs of TCI states.

In some implementations, if a UE is provided with more than one configured TCI state and/or more than one configured pair of TCI states, one or more of the configured TCI states or the configured pairs of TCI states may be associated with one or more candidate cells or a target cell. In some implementations, the UE may receive a PDSCH corresponding to the activation command that may activate one of the configured TCI states. The UE may transmit, in a slot n, a PUCCH or a PUSCH with HARQ-ACK information corresponding to the PDSCH carrying the activation command.

If the UE receives the cell switch command, which may include a beam indication (e.g., a TCI state and/or a pair of TCI states) between the PDSCH corresponding to the activation command and the PUCCH or PUSCH with the HARQ-ACK information corresponding to the activation command, the UE may expect that the beam indication indicated or included in the cell switch command is the same as the beam indication (e.g., a TCI state and/or a pair of TCI states) indicated, activated, or included in the activation command. In some implementations, the UE may not expect the beam indication indicated or included in the cell switch command to be different from the beam indication indicated, activated, or included in the activation command. In some implementations, the UE may apply the beam indication indicated or included in the cell switch command. In some implementations, the UE may apply the beam indication indicated or included in the activation command.

In some implementations, the UE may ignore the beam indication indicated or included in the cell switch command. In some implementations, the UE may ignore the beam indication indicated or included in the activation command. In some implementations, the UE may not expect to receive the cell switch command, which may include a beam indication (e.g., a TCI state and/or a pair of TCI states), between the PDSCH corresponding to the activation command and the PUCCH or PUSCH with the HARQ-ACK information corresponding to the activation command. In some implementations, the UE may not transmit the PUCCH or PUSCH with the HARQ-ACK information corresponding to the activation command.

In some implementations, when the UE transmits, in a slot n1, a PUCCH with HARQ-ACK information corresponding to the PDSCH carrying the activation command and transmits, in a slot n2, a PUCCH with HARQ-ACK information corresponding to the PDSCH carrying the cell switch command, which may indicate a TCI state and/or a pair of TCI states, the UE may apply the indicated beam indication (e.g., the TCI state and/or the pair of TCI states) starting from the first slot that is after slot n+3Nₛₗₒₜ^{subframe,μ}, where the slot n may be either the slot n1 or the slot n2. In some implementations, when the UE transmits a PUCCH with a first HARQ-ACK information corresponding to the PDSCH carrying the activation command and a second HARQ-ACK information corresponding to the PDSCH carrying the cell switch command in a slot n, the UE may apply the indicated beam indication (e.g., TCI state and/or pair of TCI states) starting from the first slot that is after slot n+3Nₛₗₒₜ^{subframe,μ}.

If the UE receives the cell switch command, which may include a beam indication (e.g., a TCI state and/or a pair of TCI states) during a specific duration (e.g., the beamAppTime, a Nₛₗₒₜ^{subframe,μ} slot, a specific threshold, or the timeDurationForQCL) after the PUCCH or PUSCH with the HARQ-ACK information corresponding to the activation command is transmitted, the UE may expect that the beam indication indicated or included in the cell switch command is the same as the beam indication (e.g., a TCI state and/or a pair of TCI states) indicated, activated, or included in the activation command. In some implementations, the UE may not expect the beam indication indicated or included in the cell switch command to be different from the beam indication indicated, activated, or included in the activation command. In some implementations, the UE may apply the beam indication indicated or included in the cell switch command. In some implementations, the UE may apply the beam indication indicated or included in the activation command.

In some implementations, the UE may ignore the beam indication indicated or included in the cell switch command. In some implementations, the UE may ignore the beam indication indicated or included in the cell switch command after transmitting HARQ-ACK in response to the PDSCH carrying the activation command or the Candidate cell TCI state activation/deactivation MAC CE. In some implementations, the UE may ignore the beam indication indicated, activated, or included in the activation command. In some implementations, the UE may not expect to receive the cell switch command during a specific duration (e.g., the beamAppTime, a Nₛₗₒₜ^{subframe,μ} slot, a specific threshold, or the timeDurationForQCL) after the PUCCH or PUSCH with the HARQ-ACK information corresponding to the activation command is transmitted.

In some implementations, more than one of configured TCI states or more than one of configured pairs of TCI states may be activated for the UE via or by an activation command (e.g., a Candidate cell TCI state activation/deactivation MAC CE). It should be noted that the configured TCI states and/or pairs of TCI states may be configured to the UE via RRC signaling.

In some implementations, the DCI may indicate one of the TCI states activated by the activation command.

In some implementations, if a UE is provided with more than one configured TCI state and/or more than one pair of TCI states, one or more of the configured TCI states or the configured pairs of TCI states may be associated with one or more candidate cells or a target cell. In some implementations, an activation command may activate more than one of the configured TCI states or more than one of the configured pairs of TCI states. In some implementations, the DCI may indicate one of the TCI states or the pairs of TCI states activated by the activation command.

In some implementations, if the UE is configured with more than one TCI state and/or more than one pair of TCI states, one or more of the configured TCI states or the configured pairs of TCI states may be associated with the candidate cells and/or the target cell, and the activation command may activate one or more of the configured TCI states or the configured pairs of TCI states. The UE may detect or receive the DCI with a DCI field (e.g., a Transmission Configuration Indication field), and a codepoint of the DCI field may map to the one or more TCI states and/or the one or more pairs of TCI states activated by the activation command. In some implementations, the DCI field may indicate one of the TCI states and/or the pairs of TCI states activated by the activation command. In some implementations, the TCI state and/or the pair of TCI states mapped by the codepoint in the DCI field may be associated with the candidate cells and/or the target cell. In some implementations, the TCI state and/or the pair of TCI states indicated by the DCI field may be associated with the candidate cells and/or the target cell.

If the UE receives the cell switch command, which may include a beam indication (e.g., a TCI state and/or a pair of TCI states), between the PDSCH corresponding to an activation command and the DCI with the DCI field (e.g., the Transmission Configuration Indication field), or between the PUCCH or PUSCH with the HARQ-ACK information corresponding to the activation command and the DCI with the DCI field, the UE may expect that the beam indication indicated or included in the cell switch command is the same as the beam indication (e.g., a TCI state and/or a pair of TCI states) indicated in the DCI field. In some implementations, the UE may not expect the beam indication indicated or included in the cell switch command to be different from the beam indication indicated in the DCI field.

In some implementations, the UE may apply the beam indication indicated or included in the cell switch command. In some implementations, the UE may apply the beam indication indicated in the DCI field. In some implementations, the UE may ignore the beam indication indicated or included in the cell switch command. In some implementations, the UE may ignore the beam indication indicated by the DCI field. In some implementations, the UE may not expect to receive the cell switch command, which may include a beam indication (e.g., a TCI state and/or a pair of TCI states), between the PDSCH corresponding to the activation command and the DCI with the DCI field. In some implementations, the UE may not expect to receive the DCI with the DCI field after receiving the cell switch command. In some implementations, the UE may not be required to transmit the HARQ-ACK corresponding to the DCI with the DCI field after receiving the cell switch command. In some implementations, the UE may not expect to receive the DCI with the DCI field during a specific duration (e.g., the beamAppTime, a Nₛₗₒₜ^{subframe,μ} slot, a threshold, or the timeDurationForQCL) after receiving the cell switch command.

If the UE receives the cell switch command, which may include a beam indication (e.g., a TCI state and/or a pair of TCI states), between the DCI with the DCI field (e.g., the Transmission Configuration Indication field) and a PUCCH or PUSCH with HARQ-ACK information corresponding to the DCI, the UE may expect that the beam indication indicated or included in the cell switch command is the same as the beam indication (e.g., a TCI state and/or a pair of TCI states) indicated in the DCI field. In some implementations, the beam indication indicated in the cell switch command may correspond to more than one beam, and the DCI may further indicate a beam from the beams included in the cell switch command.

In some implementations, the beam indication indicated in the cell switch command may correspond to one or more beams, and the DCI may further indicate a beam that is different from the beam indicated in the cell switch command. In some implementations, the UE may not expect the beam indication indicated or included in the cell switch command to be different from the beam indication indicated in the DCI field. In some implementations, the UE may apply the beam indication indicated or included in the cell switch command. In some implementations, the UE may apply the beam indication indicated in the DCI field.

In some implementations, the UE may ignore the beam indication indicated or included in the cell switch command. In some implementations, the UE may ignore the beam indication indicated in the DCI field. In some implementations, the UE may not expect to receive the cell switch command, which may include a beam indication (e.g., a TCI state and/or a pair of TCI states), between the DCI with the DCI field (e.g., the Transmission Configuration Indication field) and the PUCCH or PUSCH with the HARQ-ACK information corresponding to the DCI. In some implementations, the UE may not determine to receive the DCI with the DCI field after receiving the cell switch command.

In some implementations, the UE may not expect to receive the DCI with the DCI field during a specific duration (e.g., the beamAppTime, a Nₛₗₒₜ^{subframe,μ} slot, a specific threshold, or the timeDurationForQCL) after receiving the cell switch command. In some implementations, the UE may not be required to transmit the HARQ-ACK corresponding to the DCI with the DCI field after receiving the cell switch command. In some implementations, the UE may not be required to transmit the HARQ-ACK corresponding to the DCI with the DCI field after receiving the cell switch command.

If the UE receives the cell switch command, which may include a beam indication (e.g., a TCI state and/or a pair of TCI states) during a specific duration (e.g., the beamAppTime, a Nₛₗₒₜ^{subframe,μ} slot, a specific threshold, or the timeDurationForQCL) after the PUCCH or PUSCH with the HARQ-ACK information corresponding to the DCI is transmitted, the UE may expect that the beam indication indicated or included in the cell switch command is the same as the beam indication (e.g., a TCI state and/or a pair of TCI states) indicated in the DCI. In some implementations, the UE may not expect that the beam indication indicated or included in the cell switch command may be different from the beam indication indicated in the DCI. In some implementations, the UE may apply the beam indication indicated or included in the cell switch command. In some implementations, the UE may apply the beam indication indicated in the DCI.

In some implementations, the UE may not expect to receive the cell switch command during a specific duration (e.g., the beamAppTime, a Nₛₗₒₜ^{subframe,μ} slot, a specific threshold, or the timeDurationForQCL) after the PUCCH or PUSCH with the HARQ-ACK information corresponding to the activation command is transmitted. In some implementations, the UE may transmit a PUCCH with HARQ-ACK corresponding to the cell switch command in a slot n, and the UE may apply the indicated beam indication (e.g., TCI state and/or pair of TCI states) starting from the first slot that is after slot n+3Nₛₗₒₜ^{subframe,μ}. In some implementations, the UE may apply the indicated beam indication after a specific duration (e.g., the beamAppTime, a Nₛₗₒₜ^{subframe,μ} slot, a specific threshold, or the timeDurationForQCL).

In some implementations, the specific duration and/or the specific threshold may be configured by a higher layer (e.g., the RRC layer) or a specific number of slots, symbols or msecs.

In some implementations, the activation command may be further referred to FIG. 6.1.3.14-1: TCI States Activation/Deactivation for UE-specific PDSCH MAC CE and FIG. 6.1.3.47-1: Unified TCI state activation/deactivation MAC CE in the 3GPP TS 38.321 V17.2.0.

In some implementations, the activation command may be further referred to as the Candidate Cell TCI State Activation/Deactivation MAC CE. The Candidate Cell TCI State Activation/Deactivation MAC CE may be identified by a MAC subheader with an eLCID and may have a variable size including at least one of the following fields:
Candidate Cell ID: This field may indicate the identity of an LTM candidate Cell for which the MAC CE applies, corresponding to a specific IE.
Pᵢ: This field may indicate whether each TCI codepoint has multiple TCI states or a single TCI state. If the Pᵢ field is set to 1, the i^{th} TCI codepoint may include the DL TCI state and the UL TCI state. If the Pᵢ field is set to 0, the i^{th} TCI codepoint may include only the DL/joint TCI state or the UL TCI state. The codepoint to which a TCI state is mapped may be determined by its ordinal position among all the TCI state ID fields.
D/U: This field may indicate whether the TCI state ID in the same octet is for a joint/downlink or an uplink TCI state. If this field is set to 1, the TCI state ID in the same octet may be for joint/downlink. If this field is set to 0, the TCI state ID in the same octet may be for uplink.
TCI state ID: This field may indicate the TCI state identified by TCI-StateId or TCI-UL-StateId. If D/U is set to 1, a 7-bit TCI state ID (e.g., the TCI-StateId) may be used. If D/U is set to 0, the most significant bit of the TCI state ID may need to be considered as the reserved bit and the remaining 6 bits may indicate the TCI-UL-StateId. The maximum number of the activated TCI states may be 16.
R: Reserved bit, set to 0.

In some implementations, if a UE receives a first PDSCH carrying a first MAC CE corresponding to a cell switch command and the first MAC CE includes one or more TCI states, the UE may transmit a first HARQ-ACK corresponding to the first MAC CE and start applying the one or more TCI states after a first specific duration.

In some implementations, the UE may receive a first PDSCH carrying a first MAC CE corresponding to a cell switch command between a second PDSCH carrying a second MAC CE corresponding to an activation command and a second HARQ-ACK corresponding to the second MAC CE.

In some implementations, the UE may receive a first PDSCH carrying a first MAC CE corresponding to a cell switch command during 3Nₛₗₒₜ^{subframe,μ} after a second HARQ-ACK corresponding to a second MAC CE that corresponds to an activation command.

In some implementations, the UE may receive a first PDSCH carrying a first MAC CE corresponding to a cell switch command between a second HARQ-ACK corresponding to a second MAC CE that corresponds to an activation command and a PDCCH with a DCI field indicating one or more TCI states.

In some implementations, the UE may receive a first PDSCH carrying a first MAC CE corresponding to a cell switch command between a PDCCH with a DCI field indicating one or more TCI states and a third HARQ-ACK corresponding to the PDCCH.

In some implementations, the UE may receive a first PDSCH carrying a first MAC CE corresponding to a cell switch command during a second specific duration configured by a higher layer parameter after a third HARQ-ACK corresponding to a PDCCH with a DCI field indicating one or more TCI states.

In some implementations, the UE may start applying the one or more TCI states after the first specific duration configured by a higher layer parameter.

In some implementations, if the HARQ-ACK corresponding to the second MAC CE is transmitted in a slot n, the UE may start applying the one or more TCI states after the first specific duration, which may start from the first slot that is after slot n+3Nₛₗₒₜ^{subframe,μ}.

In some implementations, the first specific duration and the second specific duration may be configured by the same higher layer parameter.

In some implementations, the UE may not be required to transmit the first HARQ-ACK, the second HARQ-ACK, and/or the third HARQ-ACK.

In some implementations, the UE may not expect to receive the PDCCH with a

DCI field indicating one or more TCI states.

In some implementations, the UE may transmit the first HARQ-ACK, the second

HARQ-ACK, and/or the third HARQ-ACK in the same PUCCH transmission.

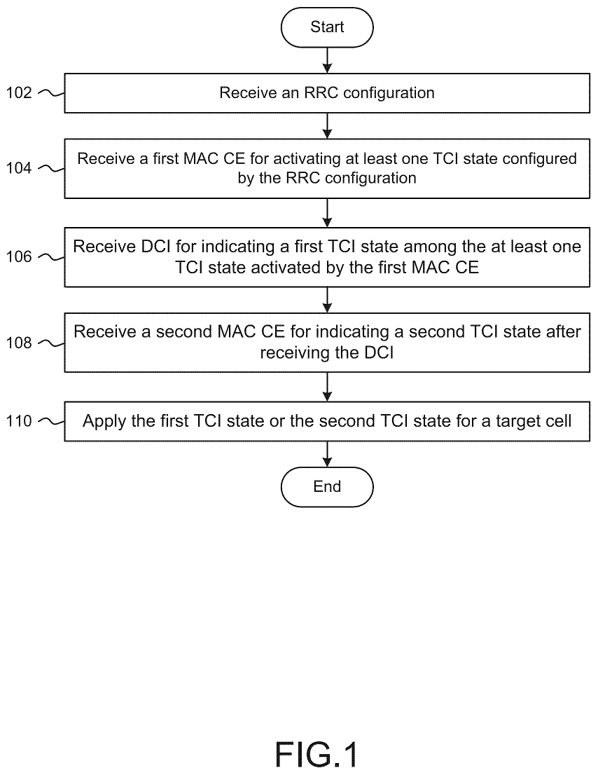

FIG. 1 is a flowchart illustrating a method/process 100 for applying a TCI state, according to an example implementation of the present disclosure. In some implementations, the process 100 may be performed by a UE.

In action 102, the process 100 may start by receiving an RRC configuration. The RRC configuration may be included in an RRC message transmitted by a network node, such as a base station or a source cell.

In action 104, the process 100 may receive a first MAC CE for activating at least one TCI state configured by the RRC configuration. In some implementations, the first MAC CE may be a Candidate cell TCI state activation/deactivation MAC CE. The first MAC CE may include an activation command for activating the at least one TCI state configured by the RRC configuration. One or more of the at least one TCI state configured by the RRC configuration may be associated with the candidate cells and/or a target cell.

In action 106, the process 100 may receive DCI for indicating a first TCI state among the at least one TCI state activated by the first MAC CE. In some implementations, the DCI may carry a TCI State indication for indicating the first TCI state among the at least one TCI state activated by the first MAC CE. In addition, the DCI may include a DCI field (e.g., a Transmission Configuration Indication field), and a codepoint of the DCI field may map to the at least one TCI state activated by the first MAC CE.

In action 108, the process 100 may receive a second MAC CE for indicating a second TCI state after receiving the DCI. The second MAC CE may include a TCI state ID for indicating the second TCI state after receiving the DCI.

In action 110, the process 100 may apply the first TCI state or the second TCI state for a target cell. The process 100 may then end.

In some implementations, the first TCI state and the second TCI state may be the same.

In some implementations, the second MAC CE may include an LTM cell switch command MAC CE. The UE may switch from a source cell to the target cell based on the LTM cell switch command MAC CE. In some implementations, the first TCI state or the second TCI state may be applied after switching to the target cell.

In some implementations, the second MAC CE may include a TCI state ID for indicating the second TCI state.

In some implementations, the second MAC CE may include an identifier associated with the target cell and timing advance information for indicating whether a time advance is valid for the target cell.

In some implementations, the UE may transmit a HARQ-ACK corresponding to the DCI after receiving the second MAC CE. In some implementations, the first TCI state or the second TCI state may be applied starting from a slot that is at least a specific duration after the transmission of the HARQ-ACK.

In some implementations, the second MAC CE may be carried by a PDSCH, and the DCI may be carried by a PDCCH. The UE may receive the PDSCH carrying the second MAC CE between the PDCCH carrying the DCI and a HARQ-ACK corresponding to the PDCCH.

In some implementations, the LTM Cell Switch Command MAC CE may be identified by a MAC subheader with an eLCID and may have a variable size with one or more of the following fields:
R: Reserved bit, set to 0.
Target Configuration ID: This field may indicate an index of a candidate target configuration to be applied for an LTM cell switch, corresponding to a specific IE (e.g., ltm-CandidateId).
Timing Advance Command: This field may indicate whether a time advance (TA) is valid for an LTM target cell (e.g., an SpCell corresponding to the target configuration indicated by the Target Configuration ID field). If the value of this field is set to FFF in hexadecimal notation (which corresponds to all 12 bits set to 1), this field may indicate that no valid timing adjustment is available for a Primary Timing Advance Group (PTAG) of the LTM target cell, and UE may perform Random Access to the LTM target cell. Otherwise, this field may indicate the index value TA used to control the amount of timing adjustment that a MAC entity has to apply, and that the UE may skip a Random Access procedure for this LTM cell switch. The length of the field may be 12 bits.
TCI state ID: This field may indicate and activate the TCI state for the LTM target cell (e.g., the SpCell of the target configuration indicated by the Target Configuration ID field). The TCI state may be identified by TCI-StateId. If the value of the unifiedTCI-State Type in the SpCell of the target configuration indicated by Target Configuration ID field is joint, this field may be for joint TCI state, otherwise, this field may be for downlink TCI state. This field may be included when the value of the Timing Advance Command field is not set to FFF. The length of the field may be 7 bits.
UL TCI state ID: This field may indicate and activate an uplink TCI state for the LTM target cell (e.g., the SpCell of the target configuration indicated by the Target Configuration ID field). The most significant bits of UL TCI state ID may need to be considered as reserved bits and the remainder 6 bits may indicate the TCI-UL-StateId. This field may be included if the value of the unifiedTCI-State Type in the SpCell corresponding to the target configuration indicated by Target Configuration ID field is separate and if the value of the Timing Advance Command field is not set to FFF. The length of the field may be 8 bits.
DL BWP ID
UL BWP ID

In some implementations, the MAC CE may correspond to a cell switch command.

In some implementations, the cell switch command processing time may include at least one of a UE reconfiguration, a DL synchronization, and a UL synchronization. In some implementations, the cell switch command processing time may include at least one of T_{RRC}, T_{processing,1}, T_{processing,2}, Tₘₑₐₛ, T_{cmd}, T_{search}, T_{Δ}, T_{margin}, T_{IU}, T_{RAR}, and T_{first-data}. Table 1 below lists the description of the parameters related to the cell switch command processing time, according to an example implementation of the present disclosure.

TABLE 1

| Component | Description |
|---|---|
| T_{RRC} | Processing time for RRCReconfiguration carrying candidate configurations. |
| T_{processing, 1} | Time for UE processing, before and after cell switch command, respectively. |
| T_{processing, 2} | This may include L2/3 reconfiguration, RF retuning, baseband retuning, |
| | security update if needed, etc. |
| Tₘₑₐₛ | Measurement delay (from target appears to the cell switch command). |
| T_{cmd} | Time for processing L1/L2-command (HARQ and parsing). |
| T_{search} | Time required to search the target cell. |
| T_{Δ} | Time for fine tracking and acquiring full timing information. |
| T_{margin} | Time for SSB or CSI-RS post-processing. |
| T_{IU} | Interruption uncertainty in acquiring the first available PRACH occasion in |
| | the new cell. |
| T_{RAR} | Time for RAR delay. |
| T_{first-data} | Time for UE to perform the first DL/UL reception and/or transmission on |
| | the indicated beam of the target cell, after RAR. |

The steps/actions shown in FIG. 1 should not be construed as necessarily order dependent. The order in which the process is described is not intended to be construed as a limitation. Moreover, some of the actions shown in FIG. 1 may be omitted in some implementations and one or more actions shown in FIG. 1 may be combined.

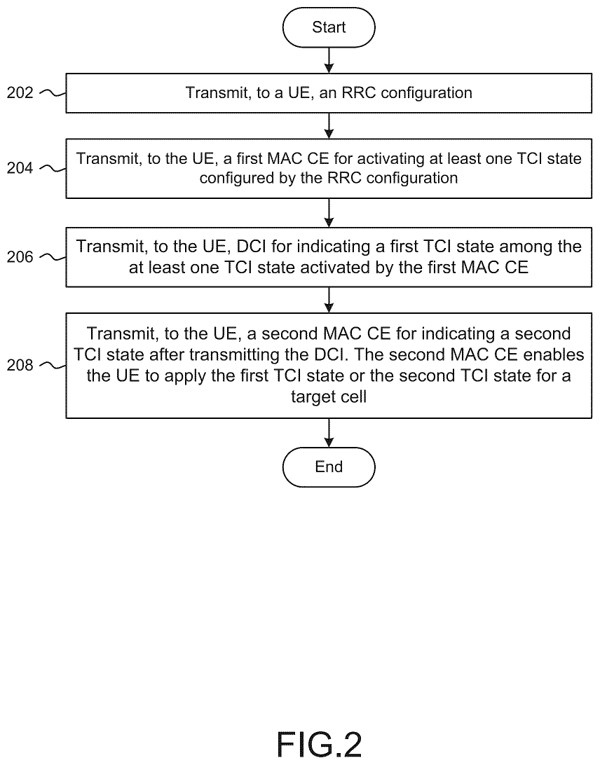

FIG. 2 is a flowchart illustrating a method/process 200 performed by a BS for configuring the LTM, according to an example implementation of the present disclosure.

In action 202, the process 200 may start by transmitting, to a UE, an RRC configuration. The RRC configuration may be included, for example, in an RRC message transmitted to the UE.

In action 204, the process 200 may transmit, to the UE, a first MAC CE for activating at least one TCI state configured by the RRC configuration. The first MAC CE may be a Candidate cell TCI state activation/deactivation MAC CE and/or may include an activation command for activating the at least one TCI state configured by the RRC configuration. One or more of the at least one TCI state configured by the RRC configuration may be associated with the candidate cells and/or a target cell.

In action 206, the process 200 may transmit, to the UE, DCI for indicating a first TCI state among the at least one TCI state activated by the first MAC CE. In some implementations, the DCI may carry a TCI State indication for indicating the first TCI state among the at least one TCI state activated by the first MAC CE. In addition, the DCI may include a DCI field (e.g., a Transmission Configuration Indication field), and a codepoint of the DCI field may map to the at least one TCI state activated by the first MAC CE.

In action 208, the process 200 may transmit, to the UE, a second MAC CE for indicating a second TCI state after transmitting the DCI. The second MAC CE may include a TCI state ID for indicating the second TCI state after receiving the DCI. The second MAC CE may enable the UE to apply the first TCI state or the second TCI state for a target cell. The process 200 may then end.

In some implementations, the first TCI state and the second TCI state may be the same.

In some implementations, the second MAC CE is an LTM cell switch command MAC CE that enables the UE to switch from a source cell to the target cell. The LTM cell switch command MAC CE may enable the UE to apply the first TCI state or the second TCI state after switching to the target cell.

In some implementations, the second MAC CE may further include an identifier associated with the target cell and timing advance information for indicating whether a time advance is valid for the target cell.

In some implementations, the DCI may further enable the UE to transmit a HARQ-ACK corresponding to the DCI after the UE receives the second MAC CE.

In some implementations, the second MAC CE may enable the UE to apply the first TCI state or the second TCI state starting from a slot that is at least a specific duration after the transmission of the HARQ-ACK.

The method illustrated in FIG. 2 is similar to that in FIG. 1, except that it is described from the perspective of the BS (instead of the UE).

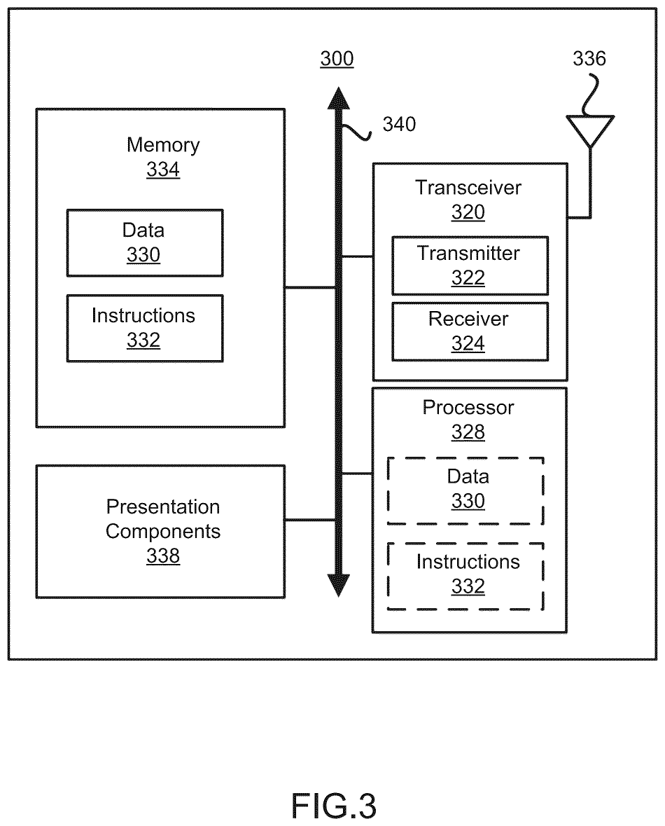

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIG. 1 and FIG. 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIG. 1 and FIG. 2. In some implementations, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for applying a Transmission Configuration Indicator (TCI) state, the method comprising:
receiving a Radio Resource Control (RRC) configuration;
receiving a first Medium Access Control (MAC) Control Element (CE) for activating at least one TCI state configured by the RRC configuration;
receiving Downlink Control Information (DCI) for indicating a first TCI state among the at least one TCI state activated by the first MAC CE;
receiving a second MAC CE for indicating a second TCI state after receiving the DCI; and
applying the first TCI state or the second TCI state for a target cell.

2. The method of claim 1, wherein the first TCI state and the second TCI state are the same.

3. The method of claim 1, further comprising:
switching from a source cell to the target cell based on the second MAC CE, wherein:
the second MAC CE comprises a Layer1/Layer2 Triggered Mobility (LTM) cell switch command MAC CE, and
the first TCI state or the second TCI state is applied after switching to the target cell.

4. The method of claim 1, wherein the second MAC CE comprises a TCI state identifier (ID) for indicating the second TCI state.

5. The method of claim 1, wherein the second MAC CE comprises an identifier associated with the target cell and timing advance information for indicating whether a time advance is valid for the target cell.

6. The method of claim 1, further comprising:
transmitting a Hybrid Automatic Repeat reQuest Acknowledgement (HARQ-ACK) corresponding to the DCI after receiving the second MAC CE.

7. The method of claim 6, wherein the first TCI state or the second TCI state is applied starting from a slot that is at least a specific duration after the transmission of the HARQ-ACK.

8. A User Equipment (UE) for applying a Transmission Configuration Indicator (TCI) state, the UE comprising:
at least one processor; and
at least one non-transitory computer-readable medium storing one or more computer-executable instructions that, when executed by the at least one processor, cause the UE to:
receive a Radio Resource Control (RRC) configuration;
receive a first Medium Access Control (MAC) Control Element (CE) for activating at least one TCI state configured by the RRC configuration;
receive Downlink Control Information (DCI) for indicating a first TCI state among the at least one TCI state activated by the first MAC CE;
receive a second MAC CE for indicating a second TCI state after receiving the DCI; and
apply the first TCI state or the second TCI state for a target cell.

9. The UE of claim 8, wherein the first TCI state and the second TCI state are the same.

10. The UE of claim 8, wherein the one or more computer-executable instructions, when executed by the at least one processor, further cause the UE to:
switch from a source cell to the target cell based on the second MAC CE, wherein:
the second MAC CE comprises a Layer1/Layer2 Triggered Mobility (LTM) cell switch command MAC CE, and
the first TCI state or the second TCI state is applied after switching to the target cell.

11. The UE of claim 8, wherein the second MAC CE comprises a TCI state identifier (ID) for indicating the second TCI state.

12. The UE of claim 8, wherein the second MAC CE comprises an identifier associated with the target cell and timing advance information for indicating whether a time advance is valid for the target cell.

13. The UE of claim 8, wherein the one or more computer-executable instructions, when executed by the at least one processor, further cause the UE to transmit a Hybrid Automatic Repeat reQuest Acknowledgement (HARQ-ACK) corresponding to the DCI after receiving the second MAC CE.

14. The UE of claim 13, wherein the first TCI state or the second TCI state is applied starting from a slot that is at least a specific duration after the transmission of the HARQ-ACK.

15. A Base Station (BS) for indicating a Transmission Configuration Indicator (TCI) state, the BS comprising:
at least one processor; and
at least one non-transitory computer-readable medium storing one or more computer-executable instructions that, when executed by the at least one processor, cause the BS to:
transmit, to a UE, a Radio Resource Control (RRC) configuration;
transmit, to the UE, a first Medium Access Control (MAC) Control Element (CE) for activating at least one TCI state configured by the RRC configuration;
transmit, to the UE, Downlink Control Information (DCI) for indicating a first TCI state among the at least one TCI state activated by the first MAC CE; and
transmit, to the UE, a second MAC CE for indicating a second TCI state after transmitting the DCI,
wherein the second MAC CE enables the UE to apply the first TCI state or the second TCI state for a target cell.

16. The BS of claim 15, wherein the first TCI state and the second TCI state are the same.

17. The BS of claim 15, wherein:
the second MAC CE comprises a Layer1/Layer2 Triggered Mobility (LTM) cell switch command MAC CE that enables the UE to switch from a source cell to the target cell, and
the LTM cell switch command MAC CE enables the UE to apply the first TCI state or the second TCI state after switching to the target cell.

18. The BS of claim 15, wherein the second MAC CE comprises a TCI state identifier (ID) for indicating the second TCI state, an identifier associated with the target cell, and timing advance information for indicating whether a time advance is valid for the target cell.

19. The BS of claim 15, wherein the DCI further enables the UE to transmit a Hybrid Automatic Repeat reQuest Acknowledgement (HARQ-ACK) corresponding to the DCI after the UE receives the second MAC CE.

20. The BS of claim 19, wherein the second MAC CE enables the UE to apply the first TCI state or the second TCI state starting from a slot that is at least a specific duration after the transmission of the HARQ-ACK.
